(19) United States
(12) Patent Application Publication
(10) Pub. No.: US 2010/0291431 A1
(43) Pub. Date: Nov. 18, 2010

(54) Thin film battery with protective packaging

(75) Inventors: Tung-Hsiu Shih, Ceritos, CA (US); Kai-Wei Nieh, Monrovia, CA (US); Victor Krasnov, Tarzana, CA (US)

Correspondence Address: Ashok K. Janah, 650 DELANCEY STREET, SUITE 106, SAN FRANCISCO, CA, 94107-2001, US

(73) Assignee: Front Edge Technology, Inc.

(21) Appl. No.: 12/454,255

(22) Filed: May 13, 2009

(51) Int. Cl. H01M 6/42; H01M 2/02; H01M 6/00

(52) U.S. Cl. 429/159; 429/163; 29/623.2

(57) ABSTRACT

A thin film battery comprises a support with a battery cell. A cover covers the support and a sealant extends around the battery cell, and along the side perimeter surfaces between the support and cover. A protective shell covers at least one side perimeter surface. In one version, the protective shell includes alternating layers of polymer and diamond-like carbon. The protective shell increases the thin film battery cell's resistance to atmospheric and environmental degradation.

### BACKGROUND

Embodiments of the present invention relate to thin film batteries and their fabrication methods.

Thin film batteries are used in applications that require a small battery with a high energy density such as, for example, portable electronics, medical devices and space systems. A typical thin film battery typically comprises a support having one or more battery component films that include an electrolyte sandwiched between electrode films, such as an anode, cathode, and/or current collectors, that cooperate to store electrical charge and generate a voltage. The battery component films are thinner than conventional batteries, for example, the films can have thicknesses of less than 100 microns. This allows thin film batteries to have thicknesses which are 100 times smaller than the thickness of conventional batteries. The thin battery component films are often formed by processes such as physical and chemical vapor deposition (PVD or CVD), oxidation, nitridation, and electroplating processes. Thin film batteries can either be used individually or multiple thin film batteries can be stacked together to provide more power or more energy.

Thin film batteries, like most other rechargeable batteries, are sensitive to moisture and many other components in the air. Oxygen, nitrogen, carbon monoxide, carbon dioxide, moisture and even organic solvents present in the atmosphere, can react with the component films in a thin film battery. Thus, thin film batteries often need to be closed off or sealed from air or the external environment.

Conventional methods of protecting a thin film battery with a covering film have problems. In these methods, a covering film having a low water permeability in the direction perpendicular to its surface is used to cover a battery. The exposed side edges between the battery surface and the covering material is sealed with a polymeric material. If the height of the gap (therefore the thickness of the polymer) is small and the sealing width (distance from the side edge to the active battery cell) is large enough, then, for a period of time, the total amount of water that permeates through the polymer will not affect the battery performance. One example of a covering film comprises a metallized plastic film, in which the metal film serves as the primary moisture barrier. The space between the metallized plastic film and the battery surface is filled with polymer, for example, epoxy or Surlyn® (E. I. du Pont de Nemours and Company of Wilmington, Del.) which has a water permeability of 0.6 g*mm/m²/day. In one example, when a sealing edge having a width (in the vertical direction) of 3 mm and length of 10 mm, is sealed with about 50 microns of Surlyn, approximately 1 micro-gram of water permeates through the Surlyn sealed edge every day. While such a battery can be operated in air at room temperature for two to five years with this water permeation rate, however, the relatively large size of the width of the sealing edge can cause the resultant battery to become too big for applications requiring a small battery footprint. Further, for a battery made up of stacked battery cells, the metalized film cannot form a conformal shell around the 3-dimensional battery stack.

Multi-component barrier coatings which are applied on thin film batteries to reduce their gas and liquid permeability rates also have problems vis-a-vis stacked battery structures. These barrier coatings include alternating layers of metal, ceramic or polymer layers, such as aluminum, aluminum oxide and silicon dioxide, as for example described in U.S. Pat. No. 6,413,645 to Graff et al.; U.S. Pat. No. 5,725,909 to Shaw et al.; U.S. Pat. No. 5,607,789 to Treger et al.; and U.S. Pat. No. 5,681,666 also to Treger et al., all of which are incorporated by reference herein and in their entireties. Similar to the covering film, the barrier coatings have very low water permeability in the direction perpendicular to the coatings. However, water can still propagate inside the polymer layer in the direction parallel to the film surface. Therefore, a sufficiently large edge margin can be allocated to minimize the amount of water that can reach the battery films. However, in some applications the space required for an edge margin that can form an effective barrier coating is not available. Further, the barrier coating is often a two dimensional structure suitable for application to a smooth flat surface, but not good for sealing a stack of thin film batteries that has a more three dimensional structure. While individual thin film battery is sealed and then stacked, the resultant battery structure is much thicker than the original battery. For example, a typical barrier coatings is 10 micrometers thick, to seal 20 cells individually, the total thickness increase for the stack is 200 microns. This is a significant increase in the volume since a stack of 20 thin film batteries is typically only about 600 microns thick. The increased thickness and weight of such batteries reduces their energy density and specific energy. Further, such barrier coatings are fabricated by sequential deposition processes which add to fabrication costs.

For reasons including these and other deficiencies, and despite the development of various barrier coatings for thin film batteries, further improvements in protective thin battery packaging and methods of fabrication are continuously being sought.

### SUMMARY

A thin film battery comprises a battery cell on a support, the battery cell including a plurality of electrodes about an electrolyte. A cover covers the battery cell to form a plurality of side perimeter surfaces that extend around the battery cell and between the cover and support. A sealant extends along a side perimeter surface to seal off the gap between the cover and support. A protective shell covers the sealant. First and second terminals extend out of at least one of the protective shell, support or cover, the first and second terminals being connected to different electrodes of the battery cell.

A battery manufacturing method comprises forming a battery cell on a support, the battery cell comprising at least a pair of electrodes about an electrolyte. A cover is aligned over the battery cell, thereby forming a plurality of open side perimeter surfaces between the cover and the support. At least one side perimeter surface is sealed with a sealant. A protective shell is formed to covers the sealed side perimeter surface. First and second terminals are formed to extend out of the protective shell, cover or support, with the first terminal being connected to an electrode of the battery cell, and the second terminal being connected to another electrode of the battery cell.

Batteries having battery stacks comprising a plurality of battery cells arranged in a horizontal or vertical configuration are also described.

### DRAWINGS

These features, aspects, and advantages of the present invention will become better understood with regard to the following description, appended claims, and accompanying drawings, which illustrate examples of the invention. However, it is to be understood that each of the features can be used in the invention in general, not merely in the context of the particular drawings, and the invention includes any combination of these features, where:

FIG. 1 is a sectional side view of an exemplary embodiment of a battery cell on a support and showing a sealant around the battery cell;

FIG. 2 is a flowchart illustrating a process of forming an exemplary battery cell;

FIG. 3 is a top plan view of the battery cell fitted in the interior open cutout of a rectangular sealant film;

FIG. 4 shows the support of FIG. 3 with a cover over the battery cell and shadow masks over a portion of an anode current collector and cathode current collector that extend out from the cover;

FIG. 5 is a sectional side view of a support having a battery cell and cover joined to the support by a sealant;

FIG. 6 is a top-plan view of a covered battery cell after the cell is cut from a larger, planar support;

FIG. 7 is a sectional side view of a support having a battery cell with an exemplary embodiment of a multi-layer protective shell;

FIG. 8 is a sectional side view of a process of forming a polymer layer around a battery cell;

FIG. 9 is a sectional side view of a vacuum deposition system for depositing a DLC layer on a battery;

FIG. 10 is a side sectional view of a battery with a protective shell and exposed terminals;

FIG. 11 is a top plan view of a support with a battery cell and adhesive around the battery component films;

FIG. 12 is a top plan view of a cover with holes drilled therethrough;

FIG. 13 is a sectional side view of a battery cell with the cover of FIG. 12, and a protective shell and terminals;

FIG. 14 is a sectional side view of a battery with protective shell and terminal contacts extending through the side of the protective shell;

FIG. 15 is a cross-sectional view of a stacked battery comprising a plurality of battery cells and a surrounding protective shell, terminals, and exposed contact areas;

FIG. 16 is a is a cross-sectional view of another embodiment of a stacked battery having battery cells on the top and bottom surfaces of a support, a surrounding protective shell, terminals, and exposed contact areas;

FIG. 17 is a top plan view of a support having a plurality of battery cells arranged side by side on a support;

FIG. 18 is a top plan view of a cover having holes for the battery cells of FIG. 17;

FIG. 19 is a cross-sectional side view of the multi-cell support of FIG. 17 with the cover of FIG. 18 in place over the battery cells;

FIG. 20 is a top plan view of the multi-cell structure of FIG. 19 after the battery cells are cut out;

FIG. 21 is a plot of the percentage of a lithium film of a thin film battery that remains un-corroded over a number of oxidation days for battery cells that are in the protective shell or not coated; and

FIG. 22 is a photograph of the lithium films of coated and non-coated battery cells after seven days of exposure to 60° C. and 100% relative humidity.

### DESCRIPTION

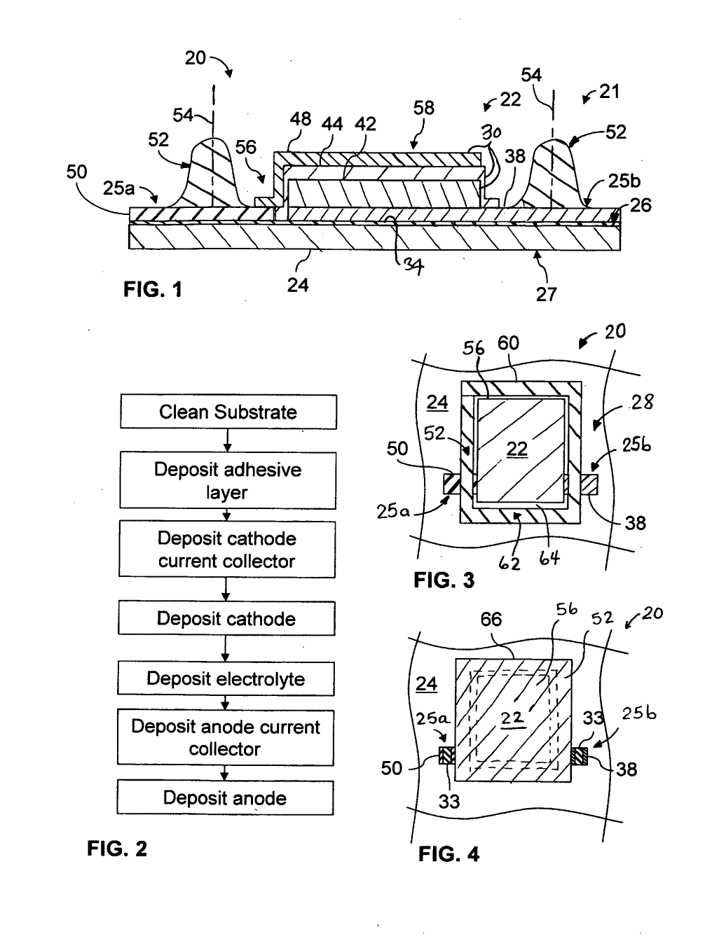

An exemplary embodiment of a thin film battery 20 comprising a battery cell 22 on a support 24, as shown in FIG. 1. The battery cell 22 is made on a support 24 which comprises a material that is impermeable, or has very low permeability, to environmental elements such as oxygen, water vapor, carbon monoxide and carbon dioxide. The support 24 should also have a relatively smooth surface and sufficient strength to support the battery component films at their fabrication and operational temperatures. For example, the support 24 can comprise aluminum, aluminum oxide, metal foil, metalized plastic film, mica, quartz, or steel. In one version, the support 24 comprises top and bottom surfaces 26, 27 which are planar.

The battery cell 22 is at least partially surrounded by a protective casing 21 which protects the battery cell 22 against harmful elements from the surrounding environment. An exemplary process of fabricating the battery cell 22 is illustrated in FIG. 2. While an exemplary embodiment of a battery structure and process of manufacture is described, it should be understood that other battery structures and fabrication processes can also be used as would be apparent to one of ordinary skill in the art. For example, the fabrication process described herein can include processes of forming a battery cell 22 which are found in, for example, commonly assigned U.S. patent application Ser. No. 12/032,997, entitled “THIN FILM BATTERY FABRICATION USING LASER SHAPING” to Nieh et al., filed on Feb. 18, 2008; and U.S. Pat. No. 6,921,464; U.S. Pat. No. 6,632,563, U.S. Pat. No. 6,863,699, and U.S. Pat. No. 7,186,479; all of which are incorporated by reference herein and in their entireties.

Referring to FIG. 2, the top and bottom surfaces 26, 27 of the support 24 are cleaned to remove surface contaminants to obtain good adherence of deposited films. For example, the support 24 can be cleaned by an annealing process in which the support is heated to temperatures sufficiently high to clean the surface by burning-off contaminants and impurities, such as organic materials, water, dust, and other materials deposited on the surfaces 26, 27. The support 24 can also be heated to temperatures sufficiently high to remove water of crystallization be present in the substrate material. The annealing temperatures and/or water of crystallization removal temperatures can be, for example, from about 150 to about 600° C., or even at least about 540° C. The annealing process can be conducted in an oxygen-containing gas, such as oxygen or air, or other gas environments, for about 10 to about 120 minutes, for example, about 60 minutes.

After a suitably clean surface is obtained, a plurality of battery component films 30 are deposited on the planar top surface 26 of the support 24, an exemplary configuration of the battery 20 being illustrated in FIG. 1. Each battery cell 22 contains terminals 25a,b connected to a set of battery component films 30 that operate to generate and store electrical energy. In one exemplary embodiment, the battery component films 30 can include, for example, an adhesion layer 34, cathode current collector 38, cathode 42, electrolyte 44, anode 48, and anode current collector 50. The adhesion layer is deposited on the planar top surface 26 of the support 24 to improve adhesion of overlying battery component films 30. The adhesion layer 34 can comprise a metal or metal compound, such as for example, aluminum, cobalt, titanium, other metals, or their alloys or compounds thereof; or a ceramic oxide such as, for example, lithium cobalt oxide. When the adhesion layer 34 is fabricated from titanium, the titanium film is deposited in a sputtering chamber with, for example, the following process conditions: argon at a pressure of 2 mTorr; DC (direct current) sputtering plasma set at a power level of 1 kW, deposition time of 30 seconds, titanium target size of 5×20 inches, and target to support distance of 10 cm. To form batteries 20 on both sides of the support, a second adhesion layer (not shown) can be deposited on the planar bottom surface 27, and a second battery cell 22 built on this surface. The adhesion layer 34 is deposited to a thickness of from about 100 to about 1500 angstroms.

A cathode current collector 38 is formed on the adhesion layer 34 to collect the electrons during charge and discharge process. The cathode current collector 38 is typically a conductor and can be composed of a metal, such as aluminum, platinum, silver or gold. The current collector 38 may also comprise the same metal as the adhesion layer 34 provided in a thickness that is sufficiently high to provide the desired electrical conductivity. A suitable thickness for the current collector 38 is from about 0.05 microns to about 2 microns. In one version, the current collector 38 comprises platinum in a thickness of about 0.2 microns. The current collector 38 can be formed by deposition of platinum by DC magnetron sputtering. The sputtering conditions for depositing a platinum film from a platinum target uses sputtering gas comprising argon at a gas pressure of 5 mTorr to form a DC plasma at a power level of 40 W for 10 minutes.

A cathode 42 comprising an electrochemically active material, is formed over the current collector 38. In one version, the cathode 42 is composed of lithium metal oxide, such as for example, lithium cobalt oxide, lithium nickel oxide, lithium manganese oxide, lithium iron oxide, or even lithium oxides comprising mixtures of transition metals such as for example, lithium cobalt nickel oxide. Other types of cathodes 42 that may be used comprise amorphous vanadium pentoxide, crystalline V₂O₅ or TiS₂. The cathode can be deposited as a single film or as a stack of films, with alternate deposition and annealing steps. Typically, the cathode stack has a thickness of at least about 5 microns, or even at least about 10 microns. The cathode 42 can be annealed to reduce stress in the film at a temperature of from about 200 to about 500° C. The cathode 42 can also be annealed in a defect reducing step to temperatures from about 150 to about 700° C., for example, about 540° C., to further improve the a quality of the cathode 42 by reducing the amount of defects.

An electrolyte 44 is formed over the cathode 42. The electrolyte 44 can be, for example, an amorphous lithium phosphorus oxynitride film, also known as a LiPON film. In one embodiment, the LiPON has the stoichiometric form LiₓPO_{y}N_{z} in an x:y:z ratio of about 2.9:3.3:0.46. In one version, the electrolyte 44 has a thickness of from about 0.1 microns to about 5 microns. This thickness is suitably large to provide sufficiently high ionic conductivity and suitably small to reduce ionic pathways to minimize electrical resistance and reduce stress.

An anode 48 is formed on the electrolyte 44, and the anode 48 can be the same material as the cathode, as already described. A suitable thickness is from about 0.1 microns to about 20 microns. In one version, anode 48 is made from lithium which is also sufficiently conductive to serve as the anode current collector 50, and in this version, the anode 48 and anode current collector 50 are made of the same material. In still another version, the anode current collector 50 is deposited onto the electrolyte 44, and the anode 48 is deposited such that extends over the electrolyte 44 and onto a portion of the anode current collector 50. In this version, the anode current collector is the same material as the cathode current collector 38 to provide a conducting surface from which electrons may be dissipated or collected from the anode 48. For example, in one version, the anode current collector 50 comprises a non-reactive metal such as silver, gold, platinum, in a thickness of from about 0.05 microns to about 5 microns. In the version shown, an anode current collector 50 is selectively deposited onto a region of the electrolyte 44. The anode 48 is then deposited onto the electrolyte 44 and part of the anode current collector 50.

The battery cell 22 comprising a plurality of battery component films 30, and/or the support 24, can also be shaped to form shaped features, for example, removing portions of the battery component films 30. The shaping processes can be performed before or the battery component films 30 are deposited on the support 24, for example after deposition of the cathode 42 and electrolyte 44, to shape one or both of these films, such as by etching away the edge portion or forming holes for the terminals 25a,b. Suitable shaping processes include pulsed laser, etching, another such processes, and these processes can be used to form the shapes of the battery component films 30 shown in FIG. 1.

After formation of the battery cell 22, a sealant 52 is applied to extend across at least one, a plurality of, or even all the side perimeter surfaces 54 which extend around the battery cell 22 to form a portion of the protective casing 21 of the battery 20. The side perimeter surfaces 54 are vertical to the planar top surface 26 of the support 24 and extend around the perimeter 56 of the battery cell 22. The sealant 52 can be made, for example, from a polymeric material, such as for example, one or more of epoxy, thermoplastic polymer, thermoset polymer, polymerized ethylene acid copolymer, hydrocarbon grease, paraffin and wax. A suitable sealant 52 comprises Epo-Tek™ 301, commercially available from Epoxy Technology, Billerica, Mass. For example, a sealant 52 comprising a viscous polymeric liquid can be applied as a thin strip that surrounds the entire perimeter 56 of the battery when cell 22, as shown in FIG. 1. The sealant 52 can also be shaped into the strip or strips by, for example, using a dispenser, screen printing, or stencil printing. In one version, the sealant 52 comprises a thickness of less than 60 microns, for example, from about 20 to about 50 microns.

Alternatively, if the sealant 52 is made of a sufficiently viscosity and compliant material, the sealant material can be applied over the whole surface of the battery cell 22 and the support 24 so that it covers the top surface of the battery cell 22 as well as the support region about the perimeter 56. In this version, the sealant 52 encases the entire battery cell 22 and planar top surface 26 of the support 24. A suitable sealant 52 for covering the entire battery cell 22 and support comprises a multilayer coating. The sealant cover can also be applied to a thickness of less than 60 microns, for example, from about 20 to about 50 microns.

The sealant 52 can also be a prefabricated sealant film 60 that is cut in a suitable shape and applied around the battery cell 22, as shown in FIG. 3. A suitable sealant film 60 comprises a compliant film comprising a thermoplastic or thermoset film. An exemplary preformed thermoset film is Surlyn®, available from E. I. du Pont de Nemours and Company of Wilmington, Del. The sealant film 60 is cut to a predefined shape and placed around the battery cell 22. For example, when the battery cell 22 has a rectangle shape, the sealant film 60 can be cut in the shape of a rectangular perimeter film 62 with a rectangular interior cutout 64 that is an open area which accommodates the battery cell 22 such that the sealant film serves like a fence to enclose and surround the battery cell 22. The rectangular perimeter film 62 surrounds the battery cell 22, which in turn, fits into the open area of the rectangular interior cutout 64. A portion of the cathode current collector 38 and part of the anode current collector 50 extend outside of the sealant enclosed area to serve as the terminals 25a,b, respectively, for connecting the battery cell 22 to the external environment. As another example, when the battery cell 22 is circular in shape, a sealant 52 comprising a circular sealant film (not shown) with an open interior circle cut-out, can be positioned around the battery cell 22.

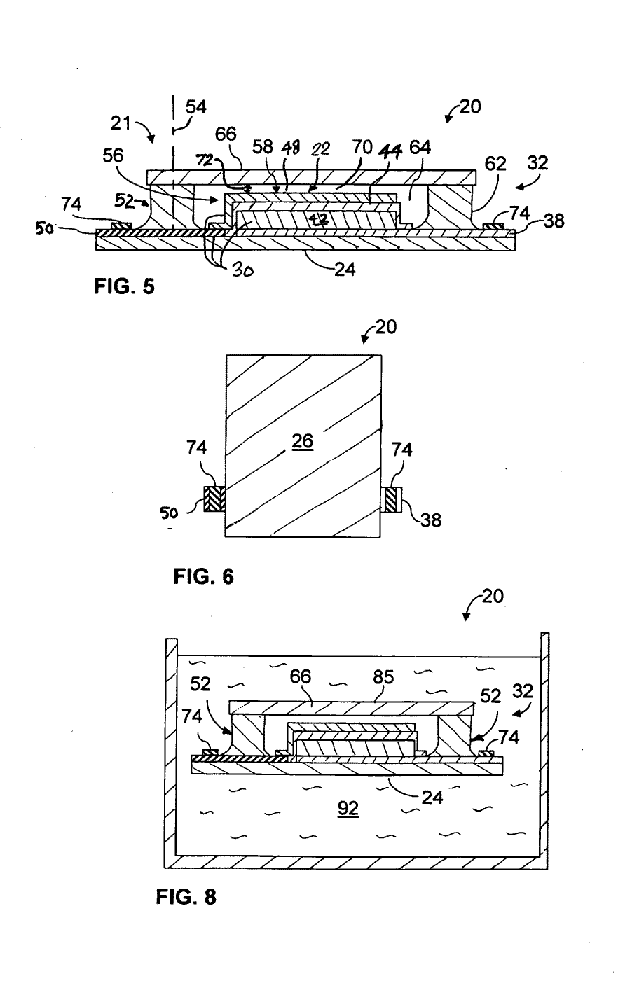

After the sealant 52 is in place, the protective casing 21 further includes a cover 66 is placed on top of the battery cell 22 with proper alignment, as shown for example in FIG. 4. In one version, the cover 66 is made from the same material as the support 24. However, the support 24 and the cover 66 can also be made from one or more different materials, including quartz, metal foil, ceramic, and metalized plastic film. They cover 66 can have a thickness of less than 50 microns, for example, from about 7 to about 40 microns.

In one version, and the cover 66 is shaped and sized so that the cathode current collector 38 and the anode current collector 50 extend out of the covered area to be exposed as the terminals 25a,b, as shown in FIG. 4. After placing the cover 66 with the proper alignment, pressure can be applied to press the support 24 and the cover 66 together. In one version, the pressure is sufficiently low to maintain a gap 70 with a gap distance 72 between the cover 66 and the top surface 58 of the battery cell 22 as shown in FIG. 5. The gap distance 72 is of the order of about 10 microns to 50 microns. Thereafter, the sealant 52 is allowed to solidify by drying or curing in the ambient environment, or in a drying oven having a positive pressure of argon or other non-reactive gas. For an epoxy sealant such as Epo-Tek301, the cure time is about 1-2 hours at 60° C. When the sealant 52 is a thermoplastic material, pressure is applied to the cover 66 while the battery cell 22 can be maintained at an elevated temperature of about 140° C. to allow the thermoplastic material to flow around the battery cell 22. As another example, if Surlyn® is used as the sealant, the temperature is maintained at about 140° C. while applying the pressure. When the sealant 52 has an adhesive quality, the sealant 52 also serves to adhere the support 24 and cover 66.

The protective casing 21 around the battery cell 22 formed by the support 24 and cover 66 cooperate to create a protective barrier that seals off the top and bottom surfaces of the battery cell 22. Further, when the support 24 and cover 66 comprise substrates having cleavage planes, such as mica, these materials can easily be made into thin sheets by splitting the material along the cleavage planes. The thin sheet can provide excellent barriers to external gases and liquids in the direction normal to the cleavage plane of supporting support 24 and cover 66, and even when the supporting substrate and the cover thickness is only several microns. Thus, a battery comprising a support 24 and cover 66 both of which are made from materials having cleavage planes, the battery can be made surprisingly thin and yet sufficiently strong for most applications.

The protective casing 21 can further include the sealant 52 provided as a coating covering the battery cell 22 and supports 24, or strip of sealant extending around the perimeter 56 of the battery cell 22. The sealant 52 further seals off the side perimeter surfaces 54 that surround the perimeter 56 of the battery cell 22 from the external environment, as shown in FIG. 5. The resultant protective casing 21 comprising the sealant 52 extending along the perimeter edges of the support 24 and cover 66 allow storage of the battery 20 between intermittent process steps, without excessive degradation of the battery component films 30 of the battery cell 22. The combination of sealing off of the surfaces parallel to the support 24 and those perpendicular to the support 24 and around the side perimeter to provide top, bottom and side edge sealing allows storage and handling of the battery cells 22 in an ambient environment without excessive degradation of the battery component films 30.

In the next step, one or more battery cells 22 are cut out of the support 24. A suitable cutting process can include laser or mechanical cutting. Shadow masks 74 can be provided prior to cutting to protect portions of the battery films 30 from subsequent cutting processes that use lasers to cut and shape the films. For example, as shown in FIG. 5, shadow masks 74 can be placed on the portions of the anode current collector 52 and the cathode current collector 38 that extend outside the temporary seal created by the sealant 52 about the perimeter 56 of the battery cell 22. The shadow mask 74 can be a mechanical mask or a polymer deposition mask.

A battery cell 22 after laser cutting is shown in FIG. 6. Laser cutting can be performed using a pulsed laser process. The pulsed laser process can be used to cut and shape a support 24 or even a structure comprising multiple stacked supports 24, as the pulsed laser process can be used cut many different structures. In one exemplary embodiment, the laser source is a femtosecond laser comprising a diode-pumped solid-state laser with a lasing medium comprising a rod of titanium doped sapphire. In another exemplary embodiment, the pulsed laser source is be an ultraviolet laser such as an excimer or ‘excited dimer’ laser, which is a chemical laser that uses a combination of an inert gas, such as argon, krypton, or xenon; and a reactive gas such as fluorine or chlorine, to generate a laser beam. Other laser sources can also be used, as would be apparent to one of ordinary skill. Several exemplary laser source and cutting methods are described in co-pending U.S. patent application Ser. No. 11/796,487 to Li et al. and co-pending U.S. patent application Ser. No. 12/032,997 to Nieh et al., both of which are incorporated by reference herein and in their entireties.

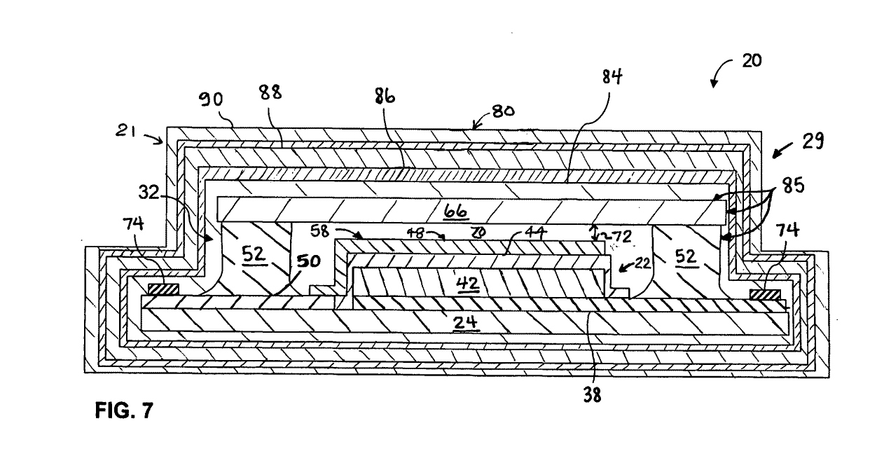

In one version, a protective shell 80 is formed on the cut and sealed-off battery cell 22 in a number of separate process steps to form a completed protective casing 21 surrounding the battery 20. An exemplary version of a protective shell 80 around a battery cell 22, as shown in FIG. 7, encloses and surrounds the entire battery cell 22. However, the protective shell 80 can be made to cover a portion of the individual batteries 20. For example, the protective shell 80 can cover at least the side perimeter surfaces 54 that extend along the sides of the cut-out battery cell 22 and enclose the sealant 52. While the side perimeter surfaces 54 of the battery cell 22 are sealed off by sealant 52, the sealant is typically at least partially permeable, and does not have the low permeability of the cover 66 or support 24. Further, the thickness and width of the sealant 52 are typically maintained at small values to minimize the volume and the weight of the battery cell 22. Thus the perimeter 56 of the battery cell 22 which faces a plurality of side perimeter surfaces 54 are particularly susceptible to permeation of harmful elements from the environment. The protective shell 80 further covers and seals-off at least the side perimeter surfaces 54 of the batteries 20 to prevent or reduce these permeation rates. When the battery cell 22 is circular in shape, the perimeter side perimeter surfaces 54 also has a circular shape; and when the battery cell 22 has a rectangular shape, the perimeter side perimeter surfaces 54 has a corresponding rectangular shape.

In one version, the protective shell 80 comprises a plurality of layers that include at least a first layer 84 and a second layer 86, that are made of different materials. For example, the first and second layers 84, 86 can be made from polymers, ceramics or metals. The resultant protective shell 80 is a laminate structure that provides a good seal along the side perimeter surfaces 54 of the battery cells 22 and battery 20, as well as low permeation rates through the vertical direction of the shell 80. The total thickness of the protective shell 80 comprising such a laminate structure can also be less than 60 microns, for example, from about 20 to about 50 microns.

In one version, the first layer 84 comprises a relatively soft and conformal material which can fill out the gaps and uneven heights of the profile of the exterior surface 85 of the enclosed battery cell 22. For example, the first layer 84 can comprise a polymer that conforms to the depressions and protrusions of the exterior surface 85. While the an embodiment of the first layer 84 is described using polymer, it should be understood that the first layer 84 can also be made from other materials as would be apparent to those of ordinary skill in the art. The selected polymer should be resistant to environmental degradation and also have a smooth surface morphology. The polymer can be a fluoropolymer such as polytetrafluoroethylene, perfluoroalkoxy polymer resin, and/or fluorinated ethylene-propylene, polyethylenetetrafluoroethylene, polyvinylfluoride, polyethylenechlorotrifluoroethylene, polyvinylidene fluoride, polychlorotrifluoro ethylene, or can be other polymers such as parylene that can be deposited using vacuum deposition technology. The polymer is, in one version, polyvinylidene difluoride (PVDF) or polyurethane. PVDF has a relatively low density (1.78) and low cost compared to the other fluoropolymers, and is sold under the tradename Kynar™ by Arkema, Inc. of Philadelphia, Pa.

In an exemplary embodiment, a first layer 84 of polymer is applied to the battery cell 22 by dip coating the cut-out battery cell 22 in a polymer solution 92, as shown in FIG. 8. The polymer solution 92 can be, for example, a polymer or copolymer dissolved in a solvent, such as PVDF dissolved in ketone. The dip-coating is performed at room temperature or other temperatures as appropriate for the polymer solution. While a dip coating process is described, other coating processes can also be used. For example, the polymer can be sprayed onto the side perimeter surfaces 54 and optional other surfaces of the battery 20. In an alternate process, a monomer material can be evaporated in a vacuum and then polymerized onto the side perimeter surfaces 54 and on other surfaces of the battery 20 to form the first layer 84. For example, a material that can be vapor deposited to form a polymer layer is Parylene.

After coating with a first layer 84 comprising a polymer, the polymer coated battery 20 is cured to condense to form a protective first layer 84 comprising a cured polymer about the battery 20, and is also dried to evaporate any remaining solvents. The drying time depends on the solvent and ambient drying temperature but is generally about 10 minutes at room temperature. For example, a first layer 84 comprising polymer can be formed in a thickness of from about 5 to about 20 microns, or even about 10 microns. The polymer also fills the gap between the support 24 and the cover 66, and the sealant 52 at the side perimeter surfaces 54 of the battery cell 22, to form a smooth coating about the battery cell 22 as shown in FIG. 7.

After coating the first layer 84, the battery cell 22 is coated with a second layer 86 made of a different material. In one version, the second layer 86 is made of a low permeation material, such as a ceramic, for example, aluminum oxide or silicon dioxide. The ceramic materials are useful for minimizing permeation and also withstanding high temperatures. The ceramic materials can be deposited by PVD or CVD. For example, aluminum oxide can be deposited by conventional PVD reactive sputtering of Aluminum in oxygen.

In another version, the second layer 86 is made from a diamond-like carbon (DLC) coating. The combination of the first layer 84 of polymer and second layer 86 of DLC provides a multilayer structure that has both some flexibility given by the polymer layer to withstand thermal or mechanical stresses, and a low permeability provided by the DLC layer. While DLC is described as an embodiment of the second layer 86, it should be understood that the second layer 86 can also be made from other materials. In one version, the DLC layer comprises an amorphous material consisting of glassy or fine crystallites of sp³ carbon structure. The diamond-like carbon layer can also comprise other elements commonly found in organic materials, such as silicon, nitrogen or hydrogen or a small amount of metal elements such as Ti, Cr, or W. In one version, the diamond-like carbon layer is formed in a thickness of from about 0.01 to about 0.8 microns, or even about 0.05 microns. The diamond-like carbon layer can be deposited in a chamber by plasma enhanced chemical vapor deposition (PECVD) of a carbon-containing gas, such as acetylene; or by other methods.

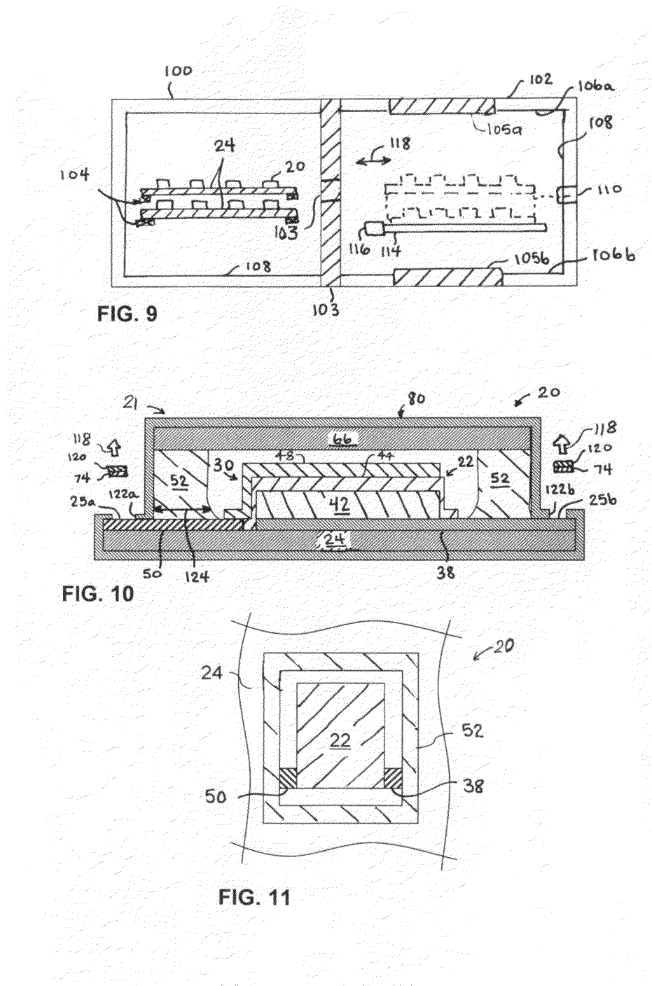

The second layer 86 comprising the diamond-like carbon coating can be deposited directly over the first polymer layer 84. In an exemplary process, a vacuum system having a load lock chamber 100 and deposition chamber 102 separated by a gate valve 103, as shown in FIG. 9, is used to deposit the DLC coating. In this process, one or more partially formed batteries 20 on supports 24 are placed on a support carrier 104 and loaded into a load lock chamber 100. The load lock chamber 100 is pumped down to a pressure of less than about 3×10⁻⁵ Torr, or even less than about 2×10⁻⁵ Torr. The process chamber 102 is prepared for processing by pumping down the process chamber to the same pressures as the load lock chamber 100. In the exemplary chamber 102, two magnetron sputtering cathodes 105a,b are mounted on two opposing chamber walls 106a,b. The sputtering targets 105a,b can comprise a metal or carbon. Some exemplary metals are chromium, molybdenum, titanium and tungsten. In one version, the targets 105a,b comprise titanium. The two targets 105a,b can be, for example, sized 5″×20″.

A pre-sputtering step is used to clean residues from the overlying sputtering targets 105a,b and chamber inner surfaces. The pre-sputtering process is conducted by providing an inert gas to the chamber 102 with a controlled flow rate and pressure and applying a power to the sputtering targets 105a,b to pre-sputter the targets for a sufficient time to clean the surface of the sputtering targets. In one embodiment, argon is provided with a flow rate of about 300±20 sccm while the chamber is maintained at a pressure of about 1.6±0.2 mTorr. A power of 2.8±0.2 kW is applied to each sputtering target 105a,b. These conditions are maintained for about 3 to 7 minutes in order to clean the surface of the sputtering targets 105a,b.

The deposition process is also conducted by providing the inert gas at the same controlled flow rate and pressure to the chamber 102 while applying power to the sputtering targets 105a,b. In addition, after the target surfaces are clean, a reactive gas of C₂H₂ (acetylene) is provided at a flow rate of about 145±10 sccm or even about 175±10 sccm, to the chamber 102. The chamber 102 is maintained at a pressure of about 1.6±0.2 mTorr and a power of 2.8±0.2 kW is applied to the sputtering targets 104. The support carrier 104 is then transported into the process chamber 102. The support carrier 104 is electrically isolated from the chamber wall 108 and connected to an electrical feed through 110 mounted on the wall 108. In one exemplary process, the support carrier is held at a DC bias, relative to an inner region of the chamber wall, of from about −5 to about −100V. The DC bias can be either from a DC power supply applying power to the support carrier 104 via the electrical feed through 110 or the floating potential of the carrier in the plasma. Once the carrier is moved to the middle of the two magnetron sputtering targets 105a,b, DLC material is deposited onto the battery cell 22.

The support carrier 104 can further comprise a conveyor 114 having a rotating mechanism 116. The conveyor 114 moves the support carrier 104 back and forth as shown by the arrow 118 between the two magnetron sputtering targets 105a,b to change the angle at which the batteries 20 on the supports 24 are exposed to the sputtering targets during deposition. The conveyor 114 and rotating mechanism 116 cooperate to ensure an even thickness of DLC coating on the top and sides of the batteries 20. The process conditions are maintained for about 6 minutes to deposit an amorphous DLC layer with a thickness of about 0.1 microns. After DLC deposition is complete, the support carrier 104 is moved into the load lock chamber 100 and the gate valve 103 between the load lock chamber 100 and process chamber 102 is closed. The load lock chamber 100 is vented and the support carrier 104 is removed. The batteries 20 on the supports 24 are removed from the carrier 104 and can be further processed.

The protective shell 80 can be further enhanced by formation of additional layers, including for example, a third layer 88 of polymer formed over the second layer 86, and even a fourth layer 88 of DLC over the third layer 88, and so on, to construct a multi-layer protective casing 21. In one embodiment, an exemplary resistance to atmospheric erosion was exhibited by a protective shell 80 comprising multi-layer coating comprising three layers of polymer and two diamond-like carbon layers, which were deposited in alternate succession. Good results were also found with an inner first layer 84 of polymer having to a thickness of from about 5 to about 30 microns, and even about 10 microns, and with third or other outer polymer layers 86 formed to a thickness of from about 1 to about 8 microns, or even about 5 microns. Both deposition processes, dip-coating and coating by magnetron sputtering, provided uniform three dimensional coating around each battery 20, to provide a good seal around the entire battery cell 22, including the side perimeter surfaces 54 of the battery cells. A final exterior layer of polymer can also be used to provide mechanical protection to the thin DLC coating underneath the final layer.

After the protective shell 80 is formed around battery cell 22, the shadow masks 74 are removed from the anode and cathode current collectors as shown in FIG. 10. This removal step also lifts off a cutout portion 120 of the protective shell 80 to expose uncoated areas of the cathode and anode current collectors, 38, 50, respectively, which are used as the terminals 25a,b to connect to the battery 22. Near the contact areas of the terminals 25a,b, edge portions 122a,b of the protective shell 80 are exposed to air. The harmful elements in the air can diffuse into the polymer layer 35a through interfaces at the edge portions 122a,b in the protective shell 80 and propagate in the direction parallel to the surface of the protective shell 80 and eventually reach the battery component films 30. However, because the first layer 85 (not shown) of the protective shell 80 is made of polymer and relatively thin (5 to about 20 microns), the length of the polymer exposed to the air is only a small fraction of the total length of the side perimeter surfaces 54, and the diffusion length is many times of the width of the sealant 52, therefore the amount of harmful elements that reach the battery component films 30 over a fixed period of time is much smaller than what would have penetrated the sealant 52 over the same time period without the protective shell 80. In this manner, the protective shell 80 greatly extends the life of the battery cell 22 in the air.

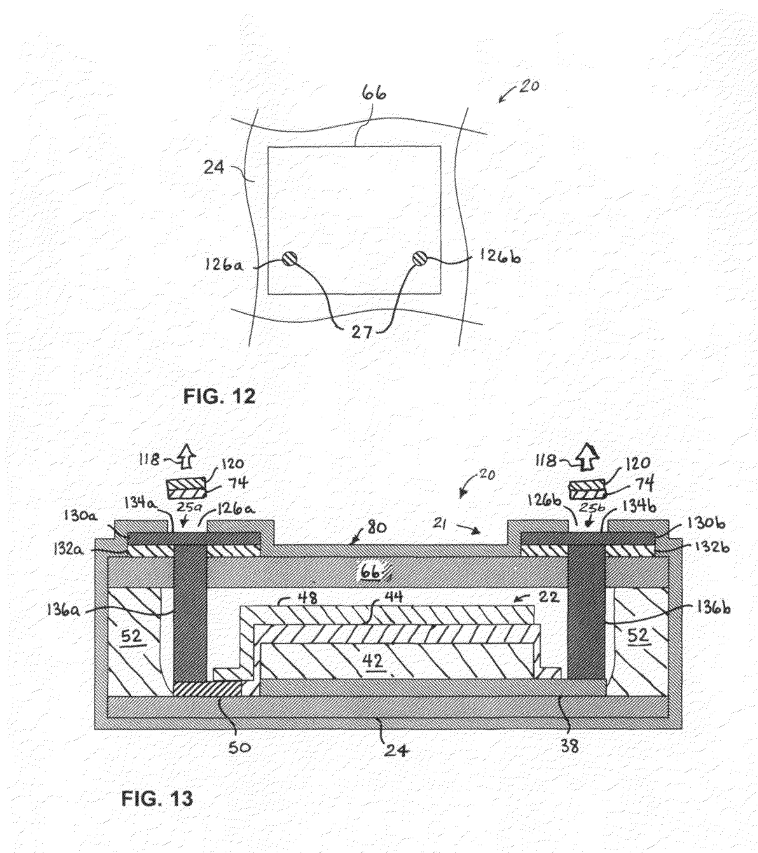

An alternate method of creating contact portions for the terminals 25a,b out of the sealed a protective shell 80 is described below. As before, the sealant 52 is applied around the side perimeter surfaces 54 at the periphery of a battery cell 22, as shown in FIG. 11. Referring to FIG. 12, two access holes 126a,b are drilled through the cover 66 such that the access holes 126a,b will be directly above selected contact portions of the cathode and anode current collectors 38, 50, which are to serve as the terminals 25a,b when the cover 66 is placed on the battery cell 22. Referring now to FIG. 13, both access holes 126a,b are covered by metal foils 130a,b, as shown in FIG. 13. The metal foils 130a,b are bigger than the access holes 126a,b by at least, for example, 1 mm. The metal foils 130a,b are attached to the cover 66 by sealant layers 132a,b such that a contact portion 134a,b of the metal foil 130a,b at each of the access holes 126a,b is not covered by sealant. The sealant layers 132a,b can be made from the same material as the sealant 52 or a different material. After the sealant layers 132a,b are cured, terminal posts 136a,b are formed through the remaining portion of the access holes 126a,b to obtain electrical contact between the metal foils 130a,b and the anode and cathode current collectors 50, 38, respectively. The terminal posts 136a,b can be made from a conductive epoxy such as CW2400 commercially available from Chemtronics®, Kennesaw, Ga. The cover 66 is then properly aligned with the cell 22 and placed on top of the cell 22 to press down on the strips of sealant 52 at the side perimeter surfaces 54 of the cell 22, as shown in FIG. 13. The terminal posts 136a,b serve to connect the anode current collector 50 and cathode current collector 38 to the metal foils 130a,b. The conductive epoxy used for the terminal posts 136a,b can be applied shortly before or after the sealant 52 is applied, and both can be cured at the same time. The contact portions 134a,b of the metal foils 130a,b are covered with shadow masks 74 (which can be a polymer deposition mask) and the protective shell 80 is formed around the battery cell 22. The shadow masks 74 are then removed with the overlying cutout portions 120 of the protective shell 80, leaving the contact portions 134a,b of the metal foils 130a,b exposed and without a protective shell to from the terminals 25a,b of the resultant battery 20.

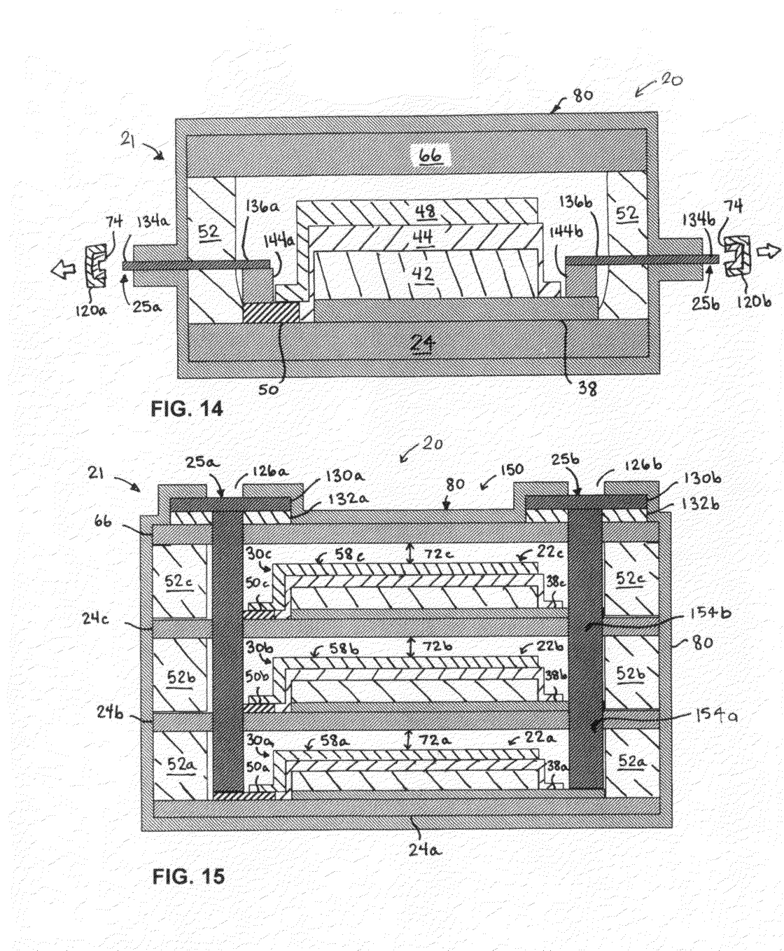

In still another version, the terminal posts 136a,b can extend through the sidewalls 140a,b of the protective shell 80 as shown in FIG. 14. In this version, terminal posts 136a,b comprising strips of metal foil or metal wires are attached to the anode current collector 50 and cathode current collector 38 by conductive pads 144a,b which can be made from the previously described conductive epoxy. The cover 66 is attached to the support 24 via the strips of sealant 52 and the terminal posts 136a,b extend through the sealant 52. The terminal posts 136a,b passing thorough the sealant 52 are surrounded by the sealant and provide no passageways for air to pass through the sealant 52. After the sealant 52 is cured, the battery cell 22 is cut from the support 24 with the protective shell 80 to form a completed battery cell 20. When forming the protective shell 80, the contact portions 134a,b of the terminal posts 136a,b which extend outside the sealant 52 and protective shell 80 are covered by a shadow masks 74, and after forming the protective shell 80, the shadow masks 74 are removed to also remove the cutout portions 120a,b and expose the contact portions 134a,b to form the terminals 25a,b of the battery 20.

While the above examples illustrate fabrication of a battery 20 comprising a single battery cell 22, the protective casing 21 can also be applied to protect a plurality of battery cells 22, which may be arranged in a linear or stacked configuration. An embodiment of a battery 20 comprising a battery stack 150 that includes a plurality of battery cells 22a-c that are each on a support 24a-c, is shown in FIG. 15. Each battery cell 22a-c comprises a plurality of component films 30a-c formed on a support 24a-c. After fabrication of the battery cells 22a-c, a sealant 52a-c is applied about the periphery of the battery cells 22a-c as described above. In the battery stack 150, the second cell 22b is positioned over the top surface 58a of the battery cell 22a, with the top surface 58b of the second cell 22b either facing toward the first cell 22a or facing away from the first cell 22a. The same process can be repeated to add more cells, such as the third cell 22c (as shown) to the stack, or even four or more cells. After stacking the cells 22a-c, a cover 66 can be positioned to the top of the battery stack 150 when the last cell is facing up. However, when the third (or last) cell 22c is facing the second cell 22b (or a previous cell before the last), then the support 24c of the final cell 22c can function as the cover. A pressure is then applied to press the supports 24a-c the cover 66 across the strips of surrounding sealant 52a-c, the pressure being sufficiently low to maintain a gap distance 72a-c between the top surfaces 59a-c of the cells 22a-c, and the next support 24b,c or the cover 66, that is in the order of about 10 microns to 50 microns per gap. Thereafter, the sealants 52a-c are allowed to solidify by drying or curing in the ambient environment, or in a holding oven having a positive pressure of argon or other non-reactive gas.

To connect the cells 22a-c, through holes 154a,b are drilled the supports 24a and 24b (not the support 24a at the bottom of the battery stack 150) using a laser. Further, an access holes 126a,b are drilled through the cover 66 immediately above the contact portions 134a,b of the bottom cell's anode current collector 50a and cathode current collector 38a, respectively. Terminal posts 136a,b are formed with conductive adhesive or wire to fill the through holes 154a,b and connect all the cells 22a-c in the battery stack 150. The through holes 154a,b can be drilled before stacking the individual cells 22a-c or after the battery stack 150 is formed. Methods of providing electrical connections of battery cells is described in co-pending U.S. patent application Ser. No. 11/946,819 to Krasnov et al. was filed on Nov. 28, 2007; and Ser. No. 11/849,959 to Wang et al. which was filed on Sep. 4, 2007, or both of which are incorporated by reference herein and in their entireties.

After the cells 22a-c in the battery stack 150 are connected, any one of the above discussed methods can be used to bring form the terminals 25a,b of the battery cells 22a,c out of the protective casing 21. For example, the cathode current collector 38 and the anode current collector 50 of any cell 22a-c in the stack, preferably the first cell 22a or the last cell 22c, can be made longer and extend out of the protective shell 80 and the same procedure as disclosed above can be used to form the terminals 25a,b for the battery stack 150. Alternatively, as shown in FIG. 15, access holes 126a,b can be drilled through the cover 66 and over the anode and cathode current collectors 50, 38. As before metal foils 130a,b and conductive pads 144a,b can be used to form the terminals 25a,b for the battery 20.

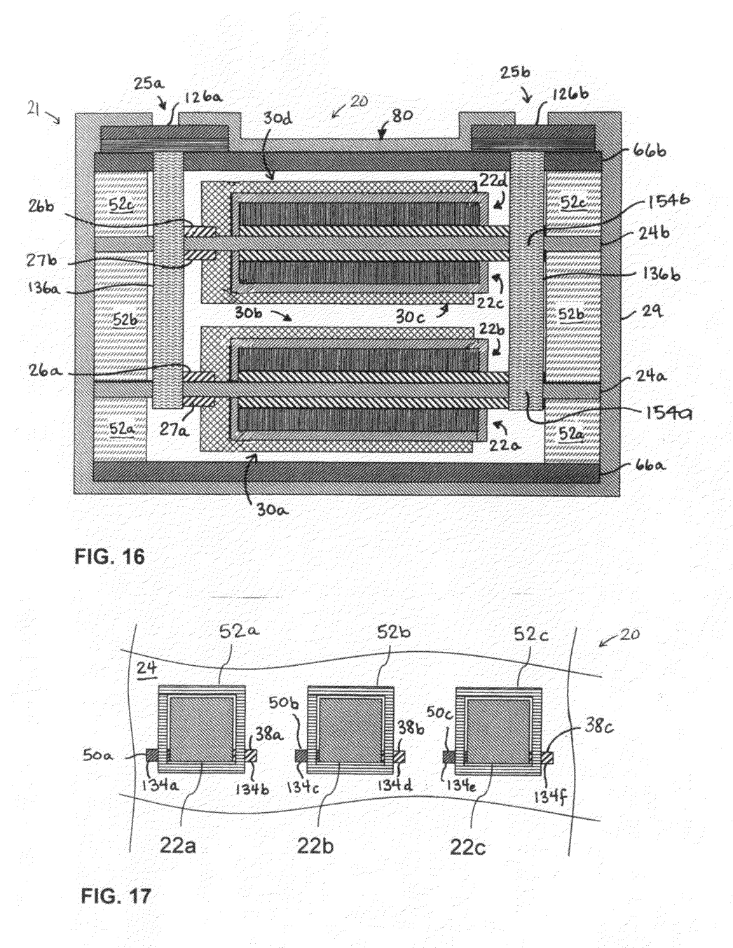

The protective casing 21 including the protective coating 80 and sealant 52 can be applied to thin film batteries 20 having other configurations. For example, a battery stack 150 can comprise cells 22a,b and 22c,d, such that pairs of cells are built on opposing surfaces of a single support 24a,b respectively, to form double-sided cell arrangements, as shown in FIG. 16. In this battery stack 150, a first battery cell 22a is formed on the planar bottom surface 27a of the first support 24a, and a second battery cell 22b is formed on the opposite, planar top surface 26a of the same support 24a. A third battery cell 22c is formed on the planar bottom surface 27b of a second support 24b, and a fourth battery cell 22d is formed on the opposite, planar top surface 26b of the same support 24b. Each battery cell 22a-d has similar structure as the single battery cell 22 previously described. This version of the battery stack 150 with two opposing cells 22a,b and 22c,d can be formed using the same processes used to form the battery 20 with a single cell 22 as described in FIGS. 1-3. For example, the supports 24a,b can each be flipped over to form the second battery cells 22b and 22c, respectively during or after processing of the first battery cells 22a,c. Alternatively, the battery film components 30b of the second battery cell 22b can be formed simultaneously with the battery film components 30a of cell 22a, using chambers having multiple process zones. For protective coating purposes the primary difference between the single-sided cell battery shown in FIG. 15 and the double-sided cell battery shown in FIG. 16 is that the support 24a,b of either of the doubled-sided cells 22a,b and 33c,d cannot be used as the cover layer of the battery 20. The first and last layer are the covers 66a,b, as shown in FIG. 16, or a single-sided cell 22 (not shown) can be formed on a support 24 and the support flipped over such that the cell 22 faces the other cells of the stack and the support 24 forms a cover to enclose the sealed volume of the battery stack 150.

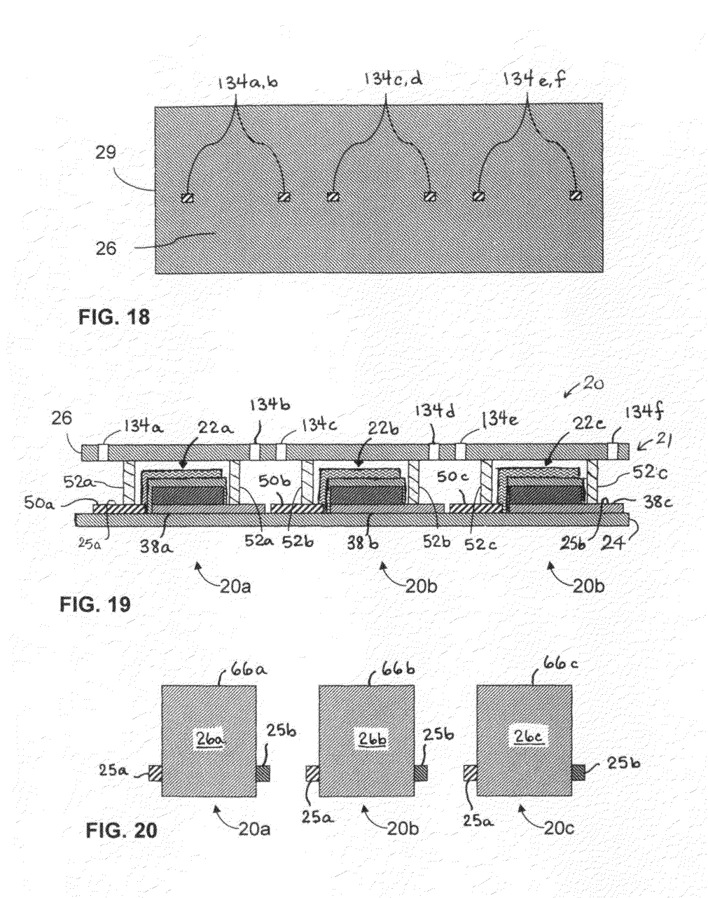

It can be beneficial to fabricate a plurality of battery cell 22a-c on the same support 24, as shown in FIG. 17. The sealant 52a-c is applied to each cell using the procedure disclosed above for individual cell. A cover 66 with drilled access holes 126a-f, as shown in FIG. 18, is positioned above the contact portions 134a-f, respectively, such that the holes 126a-f are properly aligned with the anode and cathode current collectors 50a-c, 38a-c, respectively, to form a horizontally stacked set of cells as shown in FIG. 19. The battery stack 150 includes multiple battery cells 22a-c sandwiched between the supporting support 24 and the cover 66, which can then be cut into individual batteries 20a-c, as shown in FIG. 20. Each individual battery cell 22a-c contains a support 24a-c, battery cell 22a-c, sealant 52a-c and terminals 52a,a′, b,b′, c,c′. Cutting can be performed using a mechanical or laser cutting process as disclosed above. After cutting into individual cells 22a,b, the processes to form the terminals 52a,a′, b,b′, c,c′ and protective shell 80 are the same as the processes disclosed above for single cell battery. Multiple cells 22a-c on one support 24 can also be used to form battery stacks having the cells on each support vertically aligned to cells on a second support, and so on. The battery stack 150 can be cut into smaller groups of stacked cells, to form a plurality of batteries 20 that each comprises a battery stack 150. Cutting can be performed using a mechanical or laser cutting process. In an exemplary embodiment, cutting is performed using a pulsed laser source as described above.

### EXAMPLES

The following examples are provided only to demonstrate the utility of embodiments of the battery 20 but should not be used to limit the scope of the claims. In these examples, the aging performance of batteries 20 having a protective casing 21 was compared to the aging performance of batteries 20 without the protective casing. The tests were performed by placing the batteries 20 an environmentally controlled chamber set to maintain a temperature of 60° C. and a relative humidity of 100%.

For example, the aging or environmental performance of eight (8) batteries with the protective casing 21 was compared to that of eighteen (18) batteries without the protective casing. The battery samples were placed in a testing chamber and maintained at a temperature of 60° C. with 100% relative humidity for a period of 23 days.

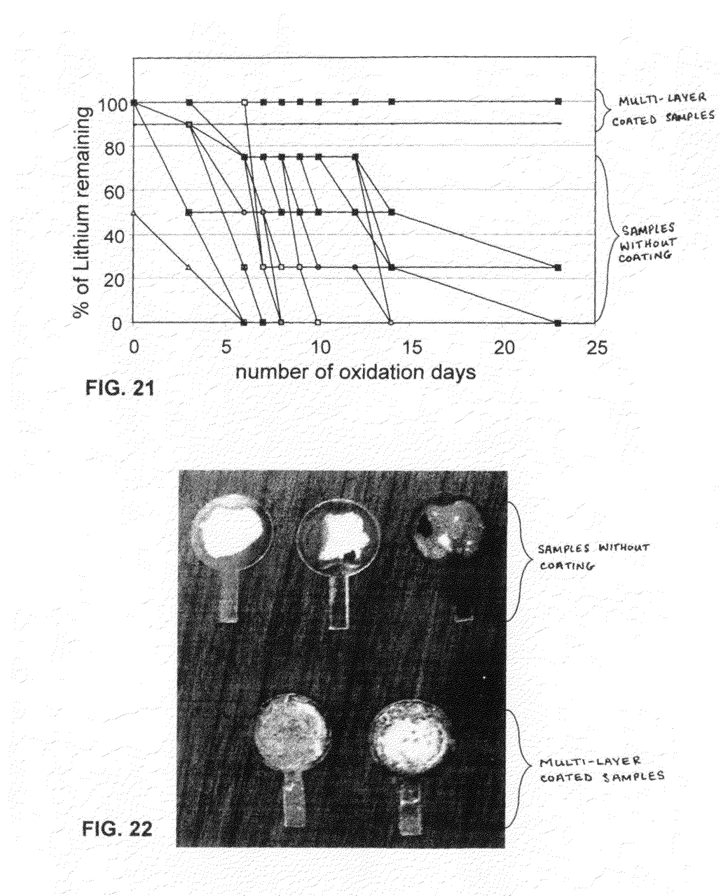

Oxidization measurements were made on the amount of lithium present in a lithium layer of the battery cells 22 of each battery 20. In all samples with the coating, the amount of lithium (Li) present in the Li layer remained unchanged between day 1 and day 23. Thus, the Li layer was not oxidized in all of the batteries 20 having the protective casing 21. In contrast, the Li layer was completely oxidized in nearly all the batteries 20 that did not have the protective casing 21 after 23 days in the chamber. The exception were non-coated battery nos. 6, 9, 11 and 17, in which only about 25% of the Li layer remained after 23 days of exposure, as illustrated in FIG. 21.

The oxidation of the Li layer of the battery cells 22 of the batteries was also visually inspected. The visual inspection was performed by depositing the Li layer onto a clear layer of mica. The batteries 20 with the protective casing 21 were fabricated so that the mica remained uncovered to serve as a window to view the physical state of the Li layer of the battery cell 22. A photographic image of five battery samples, three without the protective casing 21 and two with the protective casing 21 is shown in FIG. 22. The battery samples shown were aged for one week in a controlled chamber environment of 60° C. with 100% relative humidity. The Li layer is visible as a pale shape. Visually comparing the diameter of the Li layer, it is seen that the unprotected battery samples all experienced substantial degradation of the Li layer, while the battery samples with the protective casing retained a Li layer that extends across substantially the full diameter of the battery cell.

While illustrative embodiments of the battery 20 are described in the present application, it should be understood that other embodiments are also possible. The exemplary methods of fabricating the batteries described herein are provided only to illustrate the present invention, and other methods may be used to fabricate the battery 20 as would be apparent to those of ordinary skill in the art. Furthermore, the materials of the battery components films 30 are also exemplary and may comprise other materials. Also, the battery 20 may have a plurality of battery cells 22 arranged in a convoluted or non-symmetrical shape depending on the application. Further, the protective casing can be applied to contain and seal off other type of batteries, as would be apparent to those of ordinary skill in the art. Thus the scope of the claims should not be limited by the exemplary methods of manufacture, materials and structures provided herein.

What is claimed is:

1. A thin film battery comprising:
(a) a battery cell on a support, the battery cell comprising a plurality of electrodes about an electrolyte;
(b) a protective casing comprising:
(i) cover covering the battery cell to form a plurality of side perimeter surfaces that extend around the battery cell and between the cover and support;
(ii) a sealant along a side perimeter surface to seal off the side perimeter surface; and
(iii) a protective shell covering the sealant; and
(c) first and second terminals extending out of at least one of the protective shell, support or cover, the first and second terminals being connected to different electrodes of the battery cell.

2. A battery according to claim 1 wherein the sealant extends across all the side perimeter surfaces.

3. A battery according to claim 1 wherein the protective shell encloses the support and cover.

4. A battery according to claim 1 wherein the sealant comprises at least one of epoxy, polymerized ethylene acid copolymer, hydrocarbon grease, paraffin and wax.

5. A battery according to claim 1 wherein the sealant comprises a thickness of less than 60 microns.

6. A battery according to claim 1 wherein the protective shell comprises first and second layers that are each different materials.

7. A battery according to claim 6 wherein the first layer comprises a polymer layer and the second layer comprises a diamond-like carbon layer.

8. A battery according to claim 7 wherein the polymer layer comprises at least one of polyvinylidene difluoride and polyurethane.

9. A battery according to claim 7 wherein the diamond-like carbon layer comprises a sputtered layer.

10. A battery according to claim 6 wherein the protective shell comprises a thickness of less than 60 microns.

11. A battery according to claim 1 comprising a gap between the cover and a top surface of the battery cell, and wherein the gap distance is less than about 10 microns.

12. A battery manufacturing method comprising:
(a) forming a battery cell on a support, the battery cell comprising at least a pair of electrodes about an electrolyte;
(b) aligning a cover over the battery cell, thereby forming a plurality of open side perimeter surfaces between the cover and the support;
(c) sealing at least one side perimeter surface;
(d) forming a protective shell that covers the sealed side perimeter surface; and
(e) forming first and second terminals that extend out of the protective shell, cover or support, the first terminal being connected to an electrode of the battery cell, and the second terminal being connected to another electrode of the battery cell.

13. A method according to claim 12 comprising sealing the side perimeter surface with a sealant comprising at least one of epoxy, polymerized ethylene acid copolymer, hydrocarbon grease, paraffin and wax.

14. A method according to claim 12 comprising sealing all the side perimeter surfaces.

15. A method according to claim 14 comprising forming a protective shell around all of the side perimeter surfaces, cover and support.

16. A method according to claim 15 comprising forming a protective shell comprising first and second layers of different materials.

17. A method according to claim 16 comprising forming a protective shell that includes a first layer comprising a polymer layer and the second layer comprising a diamond-like carbon layer.

18. A method according to claim 17 wherein the polymer layer comprises at least one of polyvinylidene difluoride and polyurethane.

19. A method according to claim 17 comprising depositing the diamond-like carbon layer by magnetron sputtering.

20. A thin film battery comprising:
(a) a battery stack comprising a plurality of battery cells on one or more supports, each battery cell comprising a plurality of electrodes about an electrolyte;
(b) a cover covering the battery stack to form a plurality of side perimeter surfaces that extend around the battery stack;
(c) a sealant extending along a side perimeter surface and between the cover and support;
(d) a protective shell covering the sealant; and
(e) first and second terminals extending out of at least one of the protective shell, support or cover, the first and second terminals being connected to different electrodes of the battery cell.

21. A battery according to claim 20 wherein the sealant extends across all the side perimeter surfaces.

22. A battery according to claim 20 wherein the protective shell encloses the support and cover.

23. A battery according to claim 20 wherein the battery stack comprises a stack of supports that each has a battery cell, and wherein the battery cells are aligned to one another.

24. A battery according to claim 20 wherein the battery stack comprises a plurality of spaced apart battery cells on a support.

25. A thin film battery comprising:
(a) a battery comprising a support having planar top and bottom surfaces, and further comprising a first battery cell on the bottom surface and a second battery cell on the top surface, each battery cell comprising a plurality of electrodes about an electrolyte;
(b) a pair of covers enclosing the battery stack to define a plurality of side perimeter surfaces that extend around the battery stack;
(c) a sealant at the side perimeter surfaces and between the cover and support;
(d) a protective shell covering the sealant; and
(e) first and second terminals extending out of at least one of the protective shell, support or cover, the first and second terminals being connected to different electrodes of the battery cell.

26. A battery according to claim 25 wherein the battery cells are aligned to one another.

27. A battery according to claim 25 wherein the battery comprises a stack of supports, each support having a plurality of battery cells.
